(19) United States
(12) Patent Application Publication
(10) Pub. No.: US 2019/0379147 A1
(43) Pub. Date: Dec. 12, 2019

(54) CONNECTOR

(71) Applicant: Yazaki Corporation, Tokyo (JP)

(72) Inventor: Daisuke Nagashima, Shizuoka (JP)

(21) Appl. No.: 16/430,736

(22) Filed: Jun. 4, 2019

(30) Foreign Application Priority Data
Jun. 7, 2018 (JP) 2018-109342

(51) Int. Cl. H01R 13/18; H01R 13/11; H01R 12/58; H01R 12/73; H01R 13/24; H01R 11/11; H01R 13/631

(52) U.S. Cl. CPC H01R 13/18; H01R 13/11; H01R 12/585; H01R 13/631; H01R 13/2421; H01R 11/11; H01R 12/73

(57) ABSTRACT

A connector includes a connector main body, a first terminal that has a first support portion and a first main body portion having a first contact portion, a second terminal that has a second support portion and a second main body portion that has a second contact portion and sandwiches a counterpart terminal between itself and the first main body portion, a bus bar, and a torsion spring having a first arm portion, and a second arm portion. A first tip portion of the first arm portion energizes the first contact portion toward the second main body portion from the side opposite to the second main body portion. A second tip portion of the second arm portion energizes the second contact portion toward the first main body portion from the side opposite to the first main body portion.

### CROSS-REFERENCE TO RELATED APPLICATION(S)

The present application claims priority to and incorporates by reference the entire contents of Japanese Patent Application No. 2018-109342 filed in Japan on Jun. 7, 2018.

### BACKGROUND OF THE INVENTION

### 1. Field of the Invention

The present invention relates to a connector.

### 2. Description of the Related Art

Conventionally, there is a connector having a pair of terminals that sandwich a terminal of a counterpart connector. For example, Japanese Patent Application Laid-open No. 2016-197573 discloses a technique of a connector including a housing, a plurality of contact pairs, each of which has two contacts that are arranged and fixed in the housing and insulated from each other, and a plurality of elastic auxiliary members which correspond to the plurality of contact pairs and each of which is held by a corresponding contact pair without being fixed to the housing. The two contacts included in a contact pair respectively have contact portions coming into contact with corresponding contacts of a counterpart connector, include elastic contact pieces extending in a fitting direction with the counterpart connector, and are arranged so that the contact portions face each other. The elastic auxiliary members sandwich two contacts included in a corresponding contact pair from the outside of the contact portions facing each other and come into contact with the two contacts while maintaining insulation. According to the connector of Japanese Patent Application Laid-open No. 2016-197573, it is possible to perform reliable connection even when a plurality of contacts of a counterpart connector have variation in arrangement.

By the way, in a connector, it is desired to be able to improve contact stability between a terminal of the connector and a counterpart terminal and improve contact stability between a terminal of the connector and a bus bar in the connector while suppressing increase of the number of components.

### SUMMARY OF THE INVENTION

An object of the present invention is to provide a connector that can improve contact stability between a terminal of the connector and a counterpart terminal and improve contact stability between a terminal of the connector and a bus bar in the connector while suppressing increase of the number of components.

In order to achieve the above mentioned object, a connector according to one aspect of the present invention includes a connector main body having a wall portion and a shaft portion protruding from the wall portion; a first terminal that has a first support portion having a first insertion portion into which the shaft portion is inserted and a first main body portion that is erected on the first support portion and has a first contact portion that is a contact portion with a counterpart terminal, and that is rotatable around the shaft portion; a second terminal that has a second support portion having a second insertion portion into which the shaft portion is inserted and a second main body portion that is erected on the second support portion, has a second contact portion that is a contact portion with the counterpart terminal, and sandwiches the counterpart terminal between itself and the first main body portion, and that is rotatable around the shaft portion; a bus bar that is provided between the wall portion and the first support portion and the second support portion and is electrically connected with the first support portion and the second support portion; and a torsion spring having a coil portion that is arranged between the first main body portion and the second main body portion in a state where the shaft portion is inserted and presses the first support portion and the second support portion against the bus bar, a first arm portion extending to outside of a radial direction from an end portion of the coil portion on the wall portion side, and a second arm portion extending to the outside of the radial direction from an end portion of the coil portion on the opposite side of the wall portion side, wherein a first tip portion that is a tip portion of the first arm portion bends toward the opposite side of the wall portion side, extends along the first contact portion, and energizes the first contact portion toward the second main body portion from a side opposite to the second main body portion, and a second tip portion that is a tip portion of the second arm portion bends toward the wall portion side, extends along the second contact portion, and energizes the second contact portion toward the first main body portion from a side opposite to the first main body portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a connector according to an embodiment;

FIG. 2 is a perspective view illustrating an example of a counterpart connector;

FIG. 3 is a plan view illustrating inside of the connector according to the embodiment;

FIG. 4 is an exploded perspective view illustrating the connector according to the embodiment;

FIG. 5 is a perspective view illustrating a torsion spring of the embodiment;

FIG. 6 is a side view illustrating inside of the connector according to the embodiment;

FIG. 7 is a side view illustrating inside of the connector according to the embodiment;

FIG. 8 is a perspective view of a case of the embodiment;

FIG. 9 is a perspective view illustrating a relationship between torsion springs in a connector and a case according to the embodiment; and

FIG. 10 is an inside plan view illustrating a connection state between the connector according to the embodiment and the counterpart connector.

### DETAILED DESCRIPTION OF THE PREFERRED EMBODIMENTS

Hereinafter, a connector according to an embodiment of the present invention will be described in detail with reference to the drawings. The invention is not limited by the embodiment. Components described below include components easily conceivable by those skilled in the art and components substantially identical thereto.

### Embodiment

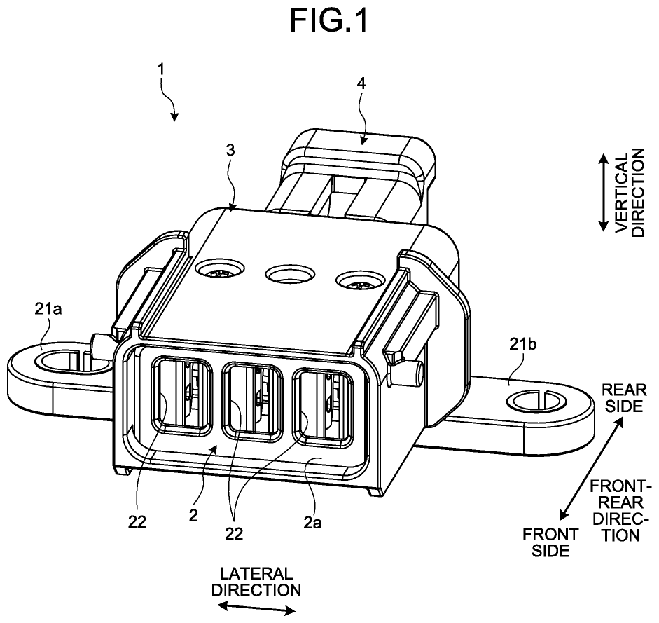

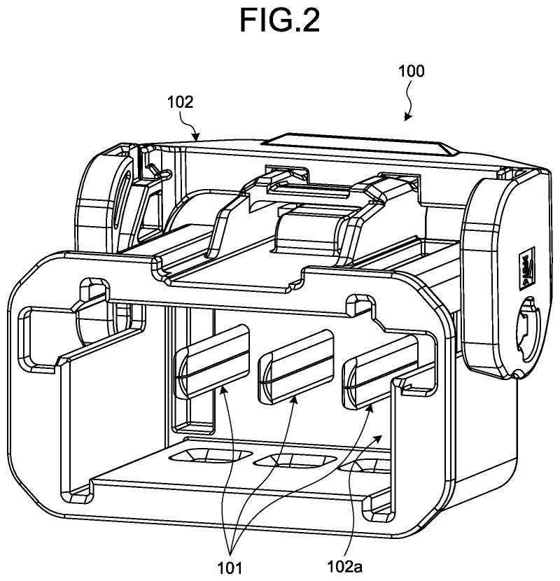

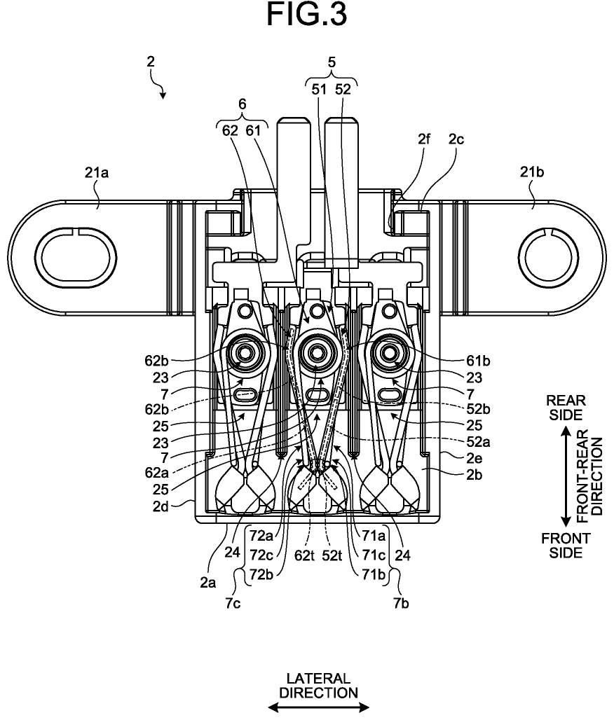

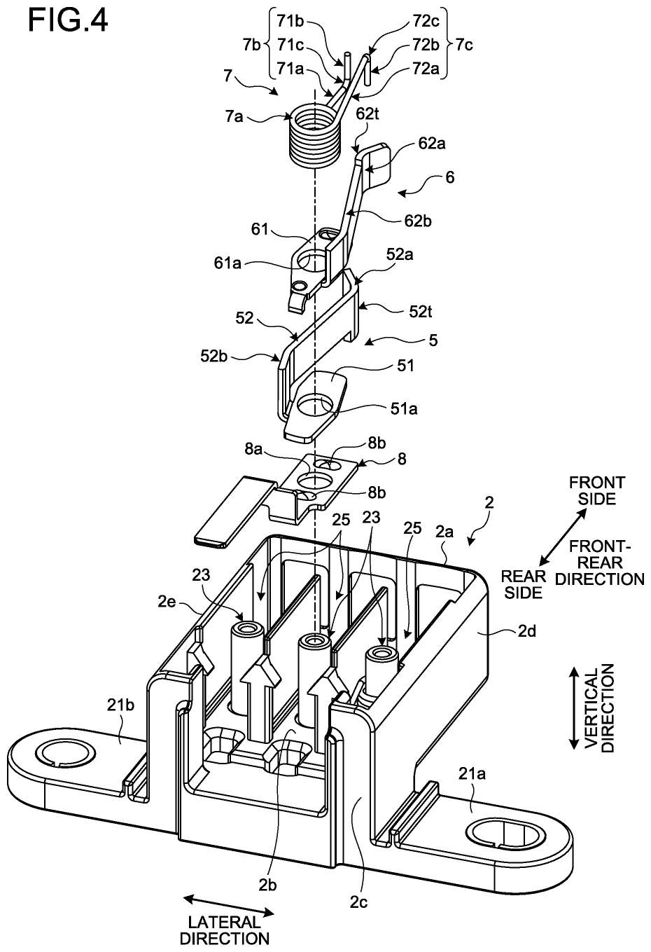

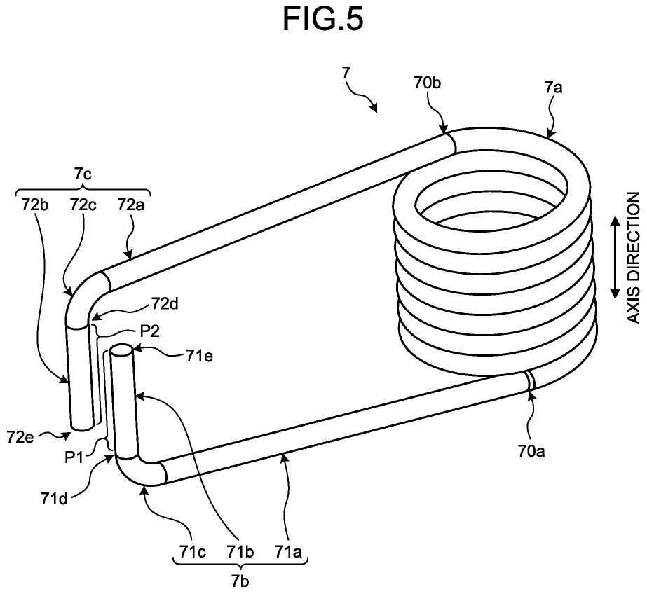

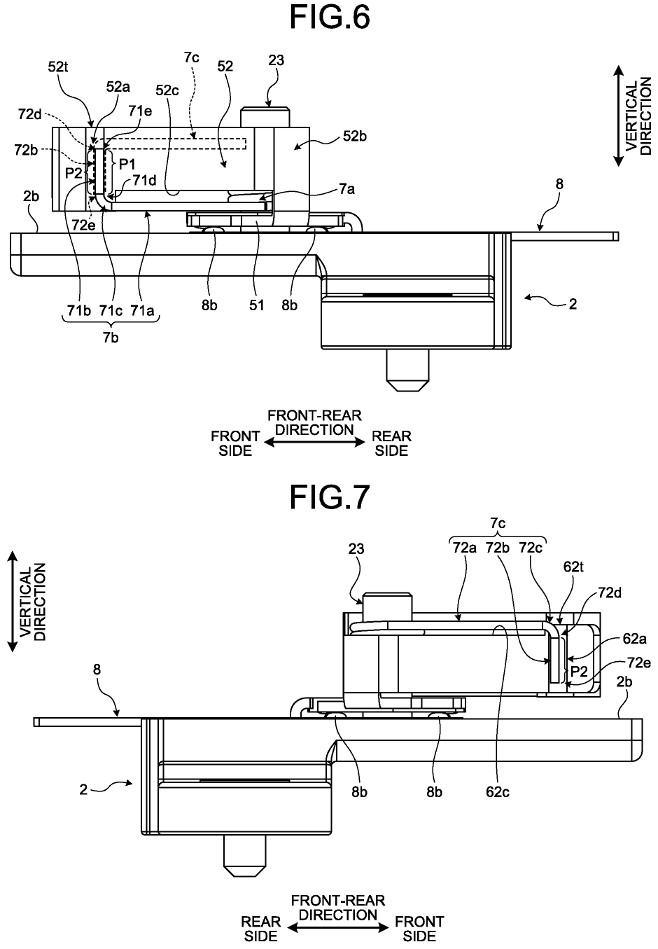

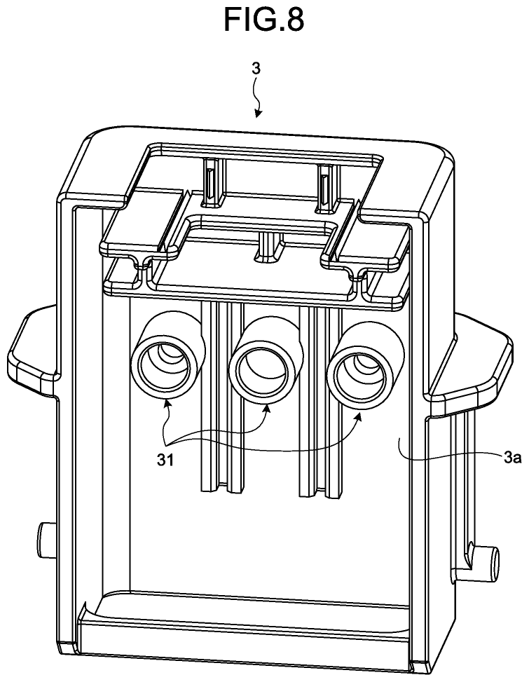

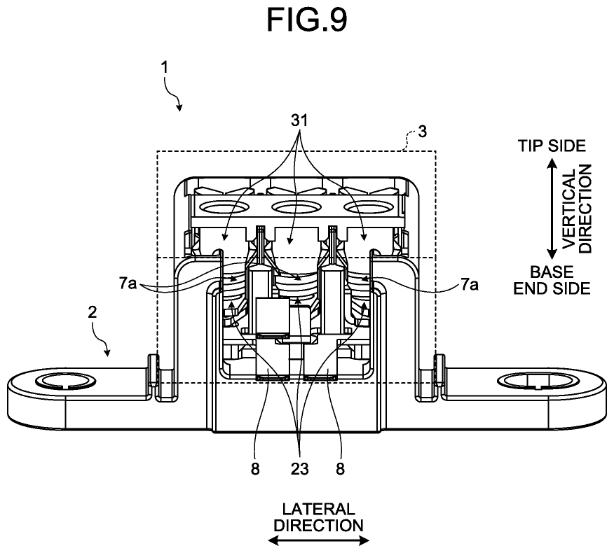

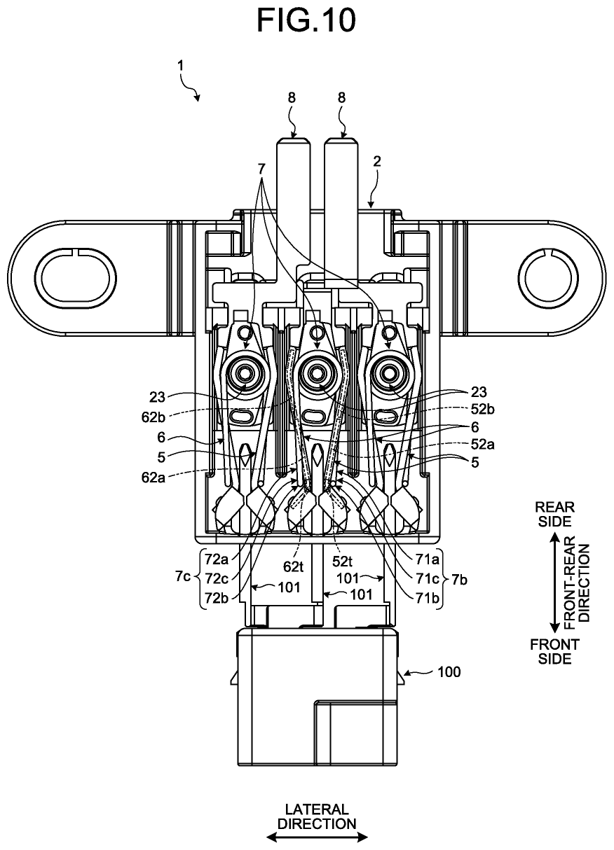

The embodiment will be described with reference to FIGS. 1 to 10. The embodiment relates to a connector. FIG. 1 is a perspective view illustrating the connector according to the embodiment. FIG. 2 is a perspective view illustrating an example of a counterpart connector. FIG. 3 is a plan view illustrating inside of the connector according to the embodiment. FIG. 4 is an exploded perspective view illustrating the connector according to the embodiment. FIG. 5 is a perspective view illustrating a torsion spring of the embodiment. FIG. 6 is a side view illustrating inside of the connector according to the embodiment. FIG. 7 is a side view illustrating inside of the connector according to the embodiment. FIG. 8 is a perspective view of a case of the embodiment. FIG. 9 is a perspective view illustrating a relationship between torsion springs in a connector and a case according to the embodiment. FIG. 10 is an inside plan view illustrating a connection state between the connector according to the embodiment and the counterpart connector.

A connector 1 illustrated in FIG. 1 is a female type connector. The connector 1 is connected with a counterpart connector 100 illustrated in FIG. 2. The connector 1 and the counterpart connector 100 are used as, for example, a power feeding connection device on a back door of a vehicle. As an example, the connector 1 of the present embodiment is arranged on the vehicle, and the counterpart connector 100 is arranged on the back door. Tabs 101 (counterpart terminals) of the counterpart connector 100 are inserted into and removed from the connector 1 by an open/close operation of the back door. When the tabs 101 are inserted into the connector 1, terminals described later (first terminal 5 and second terminal 6) of the connector 1 and the tabs 101 are electrically connected. The connector 1 and the counterpart connector 100 may be used as a power feeding connection device for a removable seat of a vehicle.

As illustrated in FIG. 1, the connector 1 has a connector main body 2, a case 3, and a housing 4. The connector 1 further includes a first terminal 5, a second terminal 6, and a torsion spring 7 described later. The connector main body 2 is a cabinet that houses the first terminal 5, the second terminal 6, the torsion spring 7, and the like. The case 3 is a cover that covers an opening portion of the connector main body 2 and forms a closed space. The housing 4 encloses bus bars 8 protruding from the connector main body 2 and functions as a fitting portion that fits with a connector of a power supply.

The connector main body 2 has opening portions 22 into which the tabs 101 of the counterpart connector 100 is inserted. The connector main body 2 has a pair of fixed portions 21a and 21b extending sideward. The fixed portions 21a and 21b are portions to be fixed to a vehicle or the like. The fixed portions 21a and 21b protrude in a direction perpendicular to a front-rear direction. Regarding the connector 1, a direction in which the counterpart connector 100 is inserted and removed is referred to as a “front-rear direction”, and a direction in which the fixed portions 21a and 21b protrude is referred to as a “lateral direction”. Regarding the connector 1, a direction perpendicular to the front-rear direction and the lateral direction is referred to as a “vertical direction”. The fixed portion 21a protrudes to one side in the lateral direction, and the fixed portion 21b protrudes to the other side in the lateral direction. The opening portions 22 are formed in a wall portion (hereinafter referred to as a “front wall portion”) 2a on one side of the connector main body 2 in the front-rear direction. In the description below, regarding the connector 1, a side connected to the counterpart connector 100 in the front-rear direction is referred to as a “front side”, and a side opposite to the front side is referred to as a “rear side”.

Three opening portions 22 are arranged side by side in the lateral direction in the front wall portion 2a. In the connector main body 2, a pair of terminals (the first terminal 5 and the second terminal 6) are arranged corresponding to one opening portion 22. As illustrated in FIG. 3, the connector main body 2 has a bottom wall portion 2b, a rear wall portion 2c, and a pair of side wall portions 2d and 2e in addition to the front wall portion 2a. The wall portions 2a, 2b, 2c, 2d, and 2e are integrally formed of synthetic resin. The bottom wall portion 2b is a rectangular-shaped plate-like component. The front wall portion 2a protrudes in the vertical direction from a front end of the bottom wall portion 2b. The rear wall portion 2c protrudes in the vertical direction from a portion near a rear end of the bottom wall portion 2b. A cutout portion 2f corresponding to the housing 4 is provided to the rear wall portion 2c. In the connector main body 2, an opening portion is formed at a portion facing the bottom wall portion 2b. The housing 4 is fixed to the connector main body 2 in a state where the housing 4 protrudes rearward from the cutout portion 2f.

A first side wall portion 2d and a second side wall portion 2e protrude in the vertical direction from lateral end portions of the bottom wall portion 2b. More specifically, the first side wall portion 2d protrudes in the vertical direction from one lateral end of the bottom wall portion 2b, and the second side wall portion 2e protrudes in the vertical direction from the other lateral end of the bottom wall portion 2b. The side wall portions 2d and 2e face each other with the bottom wall portion 2b in between in the lateral direction. Further, the wall portions 2a, 2c, 2d, and 2e and the bottom wall portion 2b form a housing space that houses the first terminal 5, the second terminal 6, and the like. The connector main body 2 has shaft portions 23 protruding in the vertical direction from the bottom wall portion 2b. The shaft portion 23 is a columnar component and perpendicular to the bottom wall portion 2b. The shaft portions 23 are arranged in central portions in the front-rear direction of the bottom wall portion 2b. In the connector main body 2 of the embodiment, three shaft portions 23 are arranged along the lateral direction.

A partition wall portion 24 is arranged in each gap between the shaft portions 23. The partition wall portion 24 is integrally formed with the bottom wall portion 2b and is a flat plate-like wall portion protruding in the vertical direction from the bottom wall portion 2b. The partition wall portion 24 partitions between a pair of terminals (first terminal 5 and second terminal 6) and another pair of terminals (first terminal 5 and second terminal 6). In the connector main body 2, terminal housing units 25 are formed by the pair of side wall portions 2d and 2e and a pair of partition wall portions 24. Each terminal housing unit 25 is arranged with a pair of terminals (first terminal 5 and second terminal 6). The connector main body 2 has three terminal housing units 25. Each terminal housing unit 25 houses a pair of terminals (first terminal 5 and second terminal 6). One pair of the three pairs of terminals (first terminal 5 and second terminal 6) is connected to a ground line and the other two pairs are connected to the power supply.

The first terminal 5 and the second terminal 6 are terminals that are electrically connected with the tab 101 of the counterpart connector 100. As illustrated in FIG. 4, the first terminal 5 has a first support portion 51 and a first main body portion 52. The first support portion 51 has a first insertion portion 51a into which the shaft portion 23 is inserted. The first main body portion 52 is erected on the first support portion 51. The first support portion 51 and the first main body portion 52 are formed of a metal or the like having conductivity. The first terminal 5 is rotatably supported around the shaft portion 23. The first terminal 5 is formed by, for example, press working or the like from one metal plate. The first main body portion 52 has a first bent portion 52a that is bent so as to be convex to one side of a plate thickness direction and a second bent portion 52b that is bent so as to be convex to the other side of the plate thickness direction. In the first main body portion 52, the first bent portion 52a is provided on a front end side and the second bent portion 52b is provided on a rear end side. The first main body portion 52 has a first contact portion 52t that is a contact portion with the tab 101. In the embodiment, in the first bent portion 52a, the first contact portion 52t is a portion to be overlapped with a surface of the tab 101 to be in contact with the first bent portion 52a in the lateral direction (see FIG. 10). The first support portion 51 is connected to a rear end portion of the first main body portion 52. A cover 9 (see FIG. 3) is attached to a front end of the first main body portion 52. The cover 9 is an insulating member formed of a synthetic resin or the like.

The second terminal 6 has a second support portion 61 and a second main body portion 62. The second support portion 61 has a second insertion portion 61a into which the shaft portion 23 is inserted. The second main body portion 62 is erected on the second support portion 61. The second main body portion 62 has a plate-like shape bending in an approximately S shape. The second support portion 61 and the second main body portion 62 are formed of a metal or the like having conductivity. The second terminal 6 is rotatably supported around the shaft portion 23. The second terminal 6 is formed by, for example, press working or the like from one metal plate. The second main body portion 62 has a first bent portion 62a that is bent so as to be convex to one side of a plate thickness direction and a second bent portion 62b that is bent so as to be convex to the other side of the plate thickness direction. In the second main body portion 62, the first bent portion 62a is provided on a front end side and the second bent portion 62b is provided on a rear end side. The second main body portion 62 has a second contact portion 62t that is a contact portion with the tab 101. In the embodiment, in the first bent portion 62a, the second contact portion 62t is a portion to be overlapped with a surface of the tab 101 to be in contact with the first bent portion 62a in the lateral direction (see FIG. 10). The second support portion 61 is connected to a rear end portion of the second main body portion 62. A cover 9 (see FIG. 3) is attached to a front end of the second main body portion 62.

The shape of the second terminal 6 is substantially plane-symmetrical to the shape of the first terminal 5. More specifically, as illustrated in FIG. 3, in a state where the first terminal 5 is arranged in the terminal housing unit 25, the shape of the first main body portion 52 in plan view is an S shape. On the other hand, in a state where the second terminal 6 is arranged in the terminal housing unit 25, the shape of the second main body portion 62 in plan view is a reversed S shape. While the first support portion 51 of the first terminal 5 is bent from the first main body portion 52 to one side of the lateral direction, the second support portion 61 of the second terminal 6 is bent from the second main body portion 62 to the other side of the lateral direction.

The first terminal 5 and the second terminal 6 are arranged so that the first bent portion 52a and the first bent portion 62a face each other in the lateral direction. The first bent portion 52a of the first terminal 5 is convex toward the second terminal 6, and the first bent portion 62a of the second terminal 6 is convex toward the first terminal 5. The first main body portion 52 and the second main body portion 62 sandwich the tab 101 of the counterpart connector 100 between the first contact portion 52t of the first bent portion 52a and the second contact portion 62t of the first bent portion 62a. By this configuration, the first terminal 5 and the second terminal 6 are electrically connected to the tab 101.

The torsion spring 7 applies a pressing force in a direction in which the first contact portion 52t and the second contact portion 62t come close together to the pair of terminals 5 and 6. More specifically, the torsion spring 7 is formed of one linear member having elasticity and has a coil portion 7a, a first arm portion 7b, and a second arm portion 7c.

The coil portion 7a is a spirally wound component. As illustrated in FIG. 5, the first arm portion 7b is an end portion of a linear member and has a first extension portion 71a and a first tip portion 71b. The first extension portion 71a is a portion that protrudes outside of a radial direction from one end 70a of the coil portion 7a and linearly extends. The first tip portion 71b is a tip portion of the first arm portion 7b. In an axis direction of the coil portion 7a, the first tip portion 71b bends toward the other end 70b of the coil portion 7a. The first tip portion 71b of the embodiment is provided as a first portion P1 that linearly extends along the axis direction of the coil portion 7a. The first tip portion 71b may have a bent portion in addition to the first portion P1.

The second arm portion 7c is an end portion of a linear member and has a second extension portion 72a and a second tip portion 72b. The second extension portion 72a is a portion that protrudes outside of a radial direction from the other end 70b of the coil portion 7a and linearly extends. The second tip portion 72b is a tip portion of the second arm portion 7c. In the axis direction of the coil portion 7a, the second tip portion 72b bends toward the one end 70a of the coil portion 7a. The second tip portion 72b of the embodiment is provided as a second portion P2 that linearly extends along the axis direction of the coil portion 7a. The second tip portion 72b may have a bent portion in addition to the second portion P1. For example, the torsion spring 7 is configured so that the first extension portion 71a and the second extension portion 72a form an acute angle on a tip portion side in a state where no external force is applied. In the embodiment, the first arm portion 7b and the second arm portion 7c extend to the outside of the radial direction of the coil portion 7a without crossing each other as viewed from the axis direction of the coil portion 7a.

In the first arm portion 7b of the embodiment, a first bent portion 71c is provided between the first extension portion 71a and the first tip portion 71b. The first bent portion 71c is bent from the first extension portion 71a to the first tip portion 71b. The first bent portion 71c is connected with a base end portion 71d of the first portion P1. The first tip portion 71b is connected with the first extension portion 71a through the first bent portion 71c, so that the first tip portion 71b is bent toward the other end 70b of the coil portion 7a in the axis direction of the coil portion 7a.

In the second arm portion 7c of the embodiment, a second bent portion 72c is provided between the second extension portion 72a and the second tip portion 72b. The second bent portion 72c is bent from the second extension portion 72a to the second tip portion 72b. The second bent portion 72c is connected with a base end portion 72d of the second portion P2. The second tip portion 72b is connected with the second extension portion 72a through the second bent portion 72c, so that the second tip portion 72b is bent toward the one end 70a of the coil portion 7a in the axis direction of the coil portion 7a.

As illustrated in FIG. 3, the shaft portion 23 is inserted into the coil portion 7a of the torsion spring 7. In the embodiment, a protruding direction of the shaft portion 23 coincides with the axis direction of the coil portion 7a. The coil portion 7a is arranged between the first main body portion 52 and the second main body portion 62. At this time, the torsion spring 7 is arranged in a posture in which the first arm portion 7b and the second arm portion 7c protrude frontward from the shaft portion 23.

As illustrated in FIG. 6, the first main body portion 52 has a first cutout portion 52c. The first cutout portion 52c is formed in an end portion of the first main body portion 52 facing the bottom wall portion 2b. The first arm portion 7b protrudes to the outside through the first cutout portion 52c and between the first main body portion 52 and the second main body portion 62. The first tip portion 71b energizes the first contact portion 52t from the side opposite to the second main body portion 62 toward the second main body portion 62. The first tip portion 71b extends along the first contact portion 52t. The first tip portion 71b is in line contact with the first contact portion 52t.

As illustrated in FIG. 7, the second main body portion 62 has a second cutout portion 62c. The second cutout portion 62c is formed in an end portion of the second main body portion 62 on a side opposite to the bottom wall portion 2b. The second arm portion 7c is guided to the outside through the second cutout portion 62c and between the first main body portion 52 and the second main body portion 62. The second tip portion 72b energizes the second contact portion 62t from the side opposite to the first main body portion 52 toward the first main body portion 52. The second tip portion 72b extends along the second contact portion 62t. The second tip portion 72b is in line contact with the second contact portion 62t.

As illustrated in FIG. 3, the first contact portion 52t and the second contact portion 62t face each other in rotation directions of the first main body portion 52 and the second main body portion 62. The first tip portion 71b and the second tip portion 72b are arranged side by side in a direction from the first contact portion 52t to the second contact portion 62t as viewed from the protruding direction of the shaft portion 23.

As illustrated in FIG. 6, at least a part of the first tip portion 71b overlaps with at least a part of the second tip portion 72b as viewed from a direction from the first contact portion 52t to the second contact portion 62t (see FIG. 3). In the embodiment, the direction from the first contact portion 52t to the second contact portion 62t is a direction perpendicular to the front-rear direction and the vertical direction (that is, the lateral direction).

When the coil portions 7a are pressed against the bus bars 8 by the case 3 described later (see FIG. 9), it is preferable that a terminal end portion 71e of the first portion P1 is located in the same position as that of the base end portion 72d of the second portion P2 in the vertical direction (the protruding direction of the shaft portion 23). Further, when the coil portions 7a are pressed against the bus bars 8 by the case 3 described later (see FIG. 9), it is preferable that a terminal end portion 72e of the second portion P2 is located in the same position as that of the base end portion 71d of the first portion P1 in the vertical direction.

The terminal end portion 71e may be located farther from a wall portion (the bottom wall portion 2b) than the base end portion 72d of the second portion P2. The terminal end portion 72e may be located closer to a wall portion (the bottom wall portion 2b) than the base end portion 71d of the first portion P1.

The torsion spring 7 sandwiches the first contact portion 52t and the second contact portion 62t by using a pair of tip portions (the first tip portion 71b and the second tip portion 72b) and generates energizing forces in rotation directions in which the first contact portion 52t and the second contact portion 62t come close to each other.

When the terminal end portion 71e is located in a range between the base end portion 72d and the terminal end portion 72e in the vertical direction, the closer the position of the terminal end portion 71e in the vertical direction to the base end portion 72d, the more the energizing force of the first tip portion 71b to the first contact portion 52t is stabilized.

When the terminal end portion 72e is located in a range between the base end portion 71d and the terminal end portion 71e in the vertical direction, the closer the position of the terminal end portion 72e in the vertical direction to the base end portion 71d, the more the energizing force of the second tip portion 72b to the second contact portion 62t is stabilized.

The bus bar 8 is a connection member having conductivity. The bus bar 8 electrically connects the first terminal 5 and the second terminal 6 to a power supply or the like mounted on a vehicle. The bus bar 8 is provided between the bottom wall portion 2b and the first and the second support portions 51 and 61. In the embodiment, the bus bar 8 has an insertion portion 8a as illustrated in FIG. 4. As illustrated in FIG. 4, when the first terminal 5, the second terminal 6, and the bus bar 8 are arranged in the terminal housing unit 25, the shaft portion 23 is inserted into the insertion portion 8a, the first insertion portion 51a, and the second insertion portion 61a in this order. Therefore, the bus bar 8 is supported by the bottom wall portion 2b of the connector main body 2, the first terminal 5 is supported by the bus bar 8, and the second terminal 6 is supported by the first terminal 5.

The bus bar 8 has protrusions 8b that slidably supports the first support portion 51 of the first terminal 5 (see FIGS. 6 and 7). The shape of the protrusion 8b is an elliptic shape. The protrusion 8b is in point or line contact with the first support portion 51. The protrusion 8b is an electrical contact point with the first support portion 51. The second terminal 6 has a protrusion on a lower surface of the second support portion 61. The protrusion of the second terminal 6 is slidably supported by the first support portion 51 of the first terminal 5. The protrusion of the second terminal 6 is an electrical contact point with the first support portion 51. The shaft portion 23 is inserted into the insertion portion 8a, the first insertion portion 51a, the second insertion portion 61a, and the torsion spring 7, so that the torsion spring 7 is assembled.

In the embodiment, the coil portion 7a is assembled by being pressed by the case 3. As illustrated in FIG. 8, pressing portions 31 are provided in the case 3. The pressing portion 31 protrudes from a surface 3a facing the bottom wall portion 2b of the connector main body 2 in the case 3. The shape of the pressing portion 31 of the embodiment is a cylindrical shape whose tip is opened. Three pressing portions 31 are arranged in parallel in the lateral direction. Each pressing portion 31 is provided at a position corresponding to the shaft portion 23 of the connector main body 2. The value of inside diameter of the pressing portion 31 is slightly larger than the value of outside diameter of the shaft portion 23. That is, the shaft portion 23 can be inserted into inside of the pressing portion 31.

As illustrated in FIG. 9, the case 3 presses the coil portions 7a against the bus bars 8. By this configuration, the coil portions 7a press the first support portions 51 and the second support portions 61 against the bus bars 8 in a state where the shaft portions 23 are inserted into the coil portions 7a.

Let us return to FIG. 2. The counterpart connector 100 has the tabs 101 and a cabinet 102. The tab 101 is a terminal of the counterpart connector 100 and is formed of a conductive metal or the like. The cabinet 102 has a fitting portion 102a having a recessed shape. The tab 101 protrudes from a bottom portion of the fitting portion 102a. The fitting portion 102a is fitted with a front end portion of the connector 1 of the embodiment. By this fitting, the tabs 101 of the counterpart connector 100 are inserted into the opening portions 22 of the connector 1.

FIG. 10 illustrates inside of the connector 1 engaged with the counterpart connector 100. As illustrated in FIG. 10, the pair of terminals 5 and 6 sandwich the tab 101 of the counterpart connector 100 by an energizing force of the torsion spring 7 and are electrically connected with the tab 101. More specifically, the pair of terminals 5 and 6 rotate around the shaft portion 23 and sandwich the tab 101 between the first contact portion 52t and the second contact portion 62t. The torsion spring 7 presses the first contact portion 52t and the second contact portion 62t against the tab 101 by using the first tip portion 71b and the second tip portion 72b and maintains an electrically connected state between the connector 1 and the counterpart connector 100.

As described above, the connector 1 of the embodiment includes the connector main body 2 having a wall portion (the bottom wall portion 2b) and the shaft portions 23 protruding from the wall portion (the bottom wall portion 2b), the first terminal 5 which has the first support portion 51 having the first insertion portion 51a into which the shaft portion 23 is inserted and the first main body portion 52 that is erected on the first support portion 51 and has the first contact portion 52t that is a contact portion with a counterpart terminal (the tab 101) and which is rotatable around the shaft portion 23, the second terminal 6 which has the second support portion 61 having the second insertion portion 61a into which the shaft portion 23 is inserted and the second main body portion 62 that is erected on the second support portion 61, has the second contact portion 62t that is a contact portion with the counterpart terminal (the tab 101), and sandwiches the counterpart terminal (the tab 101) between itself and the first main body portion 52 and which is rotatable around the shaft portion 23, the bus bar 8 which is provided between the wall portion (the bottom wall portion 2b) and the first and the second support portions 51 and 61 and is electrically connected with the first support portion 51 and the second support portion 61, and the torsion spring 7 having the coil portion 7a which is arranged between the first main body portion 52 and the second main body portion 62 in a state where the shaft portion 23 is inserted and presses the first support portion 51 and the second support portion 61 against the bus bar 8, the first arm portion 7b extending to the outside of the radial direction from an end portion of the coil portion 7a on the wall portion side (bottom wall portion 2b side), and the second arm portion 7c extending to the outside of the radial direction from an end portion of the coil portion 7a on the opposite side of the wall portion side (bottom wall portion 2b side). The first tip portion 71b which is a tip portion of the first arm portion 7b bends toward the opposite side of the wall portion side (bottom wall portion 2b side), extends along the first contact portion 52t, and energizes the first contact portion 52t toward the second main body portion 62 from the side opposite to the second main body portion 62. The second tip portion 72b which is a tip portion of the second arm portion 7c bends toward the wall portion side (bottom wall portion 2b side), extends along the second contact portion 62t, and energizes the second contact portion 62t toward the first main body portion 52 from the side opposite to the first main body portion 52.

The first tip portion 71b and the second tip portion 72b sandwich and energize contact portions (the first contact portion 52t and the second contact portion 62t) with a counterpart terminal, so that it is possible to improve contact stability of the connector 1 with the counterpart terminal. In the connector 1 of the embodiment, the first tip portion 71b and the second tip portion 72b energize the first contact portion 52t and the second contact portion 62t in directions of approaching each other. That is, the directions in which the first tip portion 71b and the second tip portion 72b energize the first contact portion 52t and the second contact portion 62t substantially coincide with the directions in which the first contact portion 52t and the second contact portion 62t rotate and sandwich the counterpart terminal. The connector 1 according to the embodiment has an effect that the contact stability of the connector 1 with the counterpart terminal can be improved by directly energizing the contact portions with the counterpart terminal by the first tip portion 71b and the second tip portion 72b. The coil portion 7a of the torsion spring 7 presses the first support portion 51 and the second support portion 61 against the bus bar 8. By this configuration, contact stability between the first and the second terminals 5 and 6 and the bus bar is improved.

That is, the torsion spring 7, which is composed of one member, of the embodiment improves the contact stability between the first and the second contact portions 52t and 62t and the counterpart terminal and the contact stability between the first and the second terminals 5 and 6 and the bus bar 8. Therefore, there is an effect that it is possible to improve the contact stability between terminals (the first and the second terminals 5 and 6) of the connector 1 and the counterpart terminal (tab 101) and the contact stability between terminals (the first and the second terminals 5 and 6) and the bus bar 8 in the connector 1.

In the connector 1 according to the embodiment, the first contact portion 52t and the second contact portion 62t face each other in rotation directions of the first main body portion 52 and the second main body portion 62, and the first tip portion 71b and the second tip portion 72b are arranged side by side in a direction from the first contact portion 52t to the second contact portion 62t as viewed from the protruding direction of the shaft portion 23.

The first contact portion 52t and the second contact portion 62t sandwich the counterpart terminal in a state where their relative positions in the front-rear direction substantially coincide with each other. By this configuration, it is possible to improve the contact stability of the connector 1 with the counterpart terminal. Further, the first tip portion 71b and the second tip portion 72b sandwich the first contact portion 52t and the second contact portion 62t in a state where relative positions of the first tip portion 71b and the second tip portion 72b in the front-rear direction substantially coincide with each other, so that it is possible to stably energize the first contact portion 52t and the second contact portion 62t in the front-rear direction. Therefore, it is possible to improve the contact stability of the connector 1 with the counterpart terminal.

In the connector 1 according to the embodiment, at least a part of the first tip portion 71b overlaps with at least a part of the second tip portion 72b as viewed from a direction from the first contact portion 52t to the second contact portion 62t.

In the connector 1 according to the embodiment, the first tip portion 71b has the first portion P1 that linearly extends along the protruding direction of the shaft portion 23, the second tip portion 72b has the second portion P2 that linearly extends along the protruding direction of the shaft portion 23, and in the protruding direction of the shaft portion 23, the terminal end portion 71e of the first portion P1 is located in the same position as that of the base end portion 72d of the second portion P2 or is located farther from the wall portion (the bottom wall portion 2b) than the base end portion 72d of the second portion P2.

In the connector 1 according to the embodiment, the first tip portion 71b has the first portion P1 that linearly extends along the protruding direction of the shaft portion 23, the second tip portion 72b has the second portion P2 that linearly extends along the protruding direction of the shaft portion 23, and in the protruding direction of the shaft portion 23, the terminal end portion 72e of the second portion P2 is located in the same position as that of the base end portion 71d of the first portion P1 or is located closer to the wall portion (the bottom wall portion 2b) than the base end portion 71d of the first portion P1.

By this configuration, the energizing forces of the first tip portion 71b and the second tip portion 72b are stably applied to the first contact portion 52t and the second contact portion 62t. The first contact portion 52t and the second contact portion 62t are sandwiched by the tip portions (the first tip portion 71b and the second tip portion 72b) extending along the vertical direction (the protruding direction of the shaft portion 23), so that, for example, even if the connector 1 vibrates, a shift in the contact portion is suppressed. Therefore, it is possible to improve the contact stability of the connector 1 with the counterpart terminal.

In the connector 1 according to the embodiment, the first tip portion 71b is in line contact with the first contact portion 52t and the second tip portion 72b is in line contact with the second contact portion 62t.

In the configuration of the embodiment, it is possible to increase contact areas between the torsion spring 7 (the first tip portion 71b and the second tip portion 72b) and the main body portions (the first contact portion 52t and the second contact portion 62t). Therefore, in the connector 1 according to the embodiment, the torsion spring 7 can stably apply the energizing forces to the contact portions (the first contact portion 52t and the second contact portion 62t).

In the connector 1 according to the embodiment, the first main body portion 52 has the first cutout portion 52c through which the first arm portion 7b extends to the outside from between the first main body portion 52 and the second main body portion 62.

In the connector 1 according to the embodiment, the second main body portion 62 has the second cutout portion 62c through which the second arm portion 7c extends to the outside from between the first main body portion 52 and the second main body portion 62.

It is possible to reduce the size of the torsion spring 7 in the vertical direction (the axis direction of the coil portion 7a) as compared with a case where the arm portions (the first arm portion 7b and the second arm portion 7c) simply cross the main body portions (the first main body portion 52 and the second main body portion 62). Therefore, it is possible to reduce the size of the connector 1 in the vertical direction.

In the embodiment described above, a configuration is described where the first arm portion 7b and the second arm portion 7c extend to the outside of the radial direction of the coil portion 7a without crossing each other as viewed from the vertical direction (the axis direction of the coil portion 7a). However, the configuration is not limited to the above configuration. For example, the first arm portion 7b and the second arm portion 7c may cross each other as viewed from the vertical direction (the axis direction of the coil portion 7a). In this case, the first tip portion 71b energizes the second contact portion 62t toward the first contact portion 52t and the second tip portion 72b energizes the first contact portion 52t toward the second contact portion 62t. Further, the first cutout portion 52c is formed in an end portion of the first main body portion 52 on a side opposite to the bottom wall portion 2b. Furthermore, the second cutout portion 62c is formed in an end portion of the second main body portion 62 facing the bottom wall portion 2b.

The connector according to the present embodiments includes a torsion spring having a coil portion that presses a first support portion and a second support portion against a bus bar, a first arm portion, and a second arm portion. A first tip portion which is a tip portion of the first arm portion bends toward an opposite side of a wall portion side, extends along a first contact portion, and energizes the first contact portion toward a second main body portion from a side opposite to the second main body portion. A second tip portion which is a tip portion of the second arm portion bends toward the wall portion side, extends along a second contact portion, and energizes the second contact portion toward a first main body portion from a side opposite to the first main body portion. According to the connector of the present invention, there is an effect that it is possible to improve contact stability between a terminal of the connector and a counterpart terminal and improve contact stability between a terminal of the connector and a bus bar in the connector while suppressing increase of the number of components.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a connector main body having a wall portion and a shaft portion protruding from the wall portion;
a first terminal that has a first support portion having a first insertion portion into which the shaft portion is inserted and a first main body portion that is erected on the first support portion and has a first contact portion that is a contact portion with a counterpart terminal, and that is rotatable around the shaft portion;
a second terminal that has a second support portion having a second insertion portion into which the shaft portion is inserted and a second main body portion that is erected on the second support portion, has a second contact portion that is a contact portion with the counterpart terminal, and sandwiches the counterpart terminal between itself and the first main body portion, and that is rotatable around the shaft portion;
a bus bar that is provided between the wall portion and the first support portion and the second support portion and is electrically connected with the first support portion and the second support portion; and
a torsion spring having a coil portion that is arranged between the first main body portion and the second main body portion in a state where the shaft portion is inserted and presses the first support portion and the second support portion against the bus bar, a first arm portion extending to outside of a radial direction from an end portion of the coil portion on the wall portion side, and a second arm portion extending to the outside of the radial direction from an end portion of the coil portion on the opposite side of the wall portion side, wherein
a first tip portion that is a tip portion of the first arm portion bends toward the opposite side of the wall portion side, extends along the first contact portion, and energizes the first contact portion toward the second main body portion from a side opposite to the second main body portion, and
a second tip portion that is a tip portion of the second arm portion bends toward the wall portion side, extends along the second contact portion, and energizes the second contact portion toward the first main body portion from a side opposite to the first main body portion.

2. The connector according to claim 1, wherein
the first contact portion and the second contact portion face each other in rotation directions of the first main body portion and the second main body portion, and
the first tip portion and the second tip portion are arranged side by side in a direction from the first contact portion to the second contact portion as viewed from a protruding direction of the shaft portion.

3. The connector according to claim 1, wherein
at least a part of the first tip portion overlaps with at least a part of the second tip portion as viewed from a direction from the first contact portion to the second contact portion.

4. The connector according to claim 2, wherein
at least a part of the first tip portion overlaps with at least a part of the second tip portion as viewed from a direction from the first contact portion to the second contact portion.

5. The connector according to claim 1, wherein
the first tip portion has a first portion that linearly extends along a protruding direction of the shaft portion,
the second tip portion has a second portion that linearly extends along the protruding direction of the shaft portion, and
in the protruding direction of the shaft portion, a terminal end portion of the first portion is located in the same position as that of a base end portion of the second portion or is located farther from the wall portion than the base end portion of the second portion.

6. The connector according to claim 2, wherein
the first tip portion has a first portion that linearly extends along a protruding direction of the shaft portion,
the second tip portion has a second portion that linearly extends along the protruding direction of the shaft portion, and
in the protruding direction of the shaft portion, a terminal end portion of the first portion is located in the same position as that of a base end portion of the second portion or is located farther from the wall portion than the base end portion of the second portion.

7. The connector according to claim 3, wherein
the first tip portion has a first portion that linearly extends along a protruding direction of the shaft portion,
the second tip portion has a second portion that linearly extends along the protruding direction of the shaft portion, and
in the protruding direction of the shaft portion, a terminal end portion of the first portion is located in the same position as that of a base end portion of the second portion or is located farther from the wall portion than the base end portion of the second portion.

8. The connector according to claim 1, wherein
the first tip portion has a first portion that linearly extends along a protruding direction of the shaft portion,
the second tip portion has a second portion that linearly extends along the protruding direction of the shaft portion, and
in the protruding direction of the shaft portion, a terminal end portion of the second portion is located in the same position as that of a base end portion of the first portion or is located closer to the wall portion than the base end portion of the first portion.

9. The connector according to claim 2, wherein
the first tip portion has a first portion that linearly extends along a protruding direction of the shaft portion,
the second tip portion has a second portion that linearly extends along the protruding direction of the shaft portion, and
in the protruding direction of the shaft portion, a terminal end portion of the second portion is located in the same position as that of a base end portion of the first portion or is located closer to the wall portion than the base end portion of the first portion.

10. The connector according to claim 3, wherein
the first tip portion has a first portion that linearly extends along a protruding direction of the shaft portion,
the second tip portion has a second portion that linearly extends along the protruding direction of the shaft portion, and
in the protruding direction of the shaft portion, a terminal end portion of the second portion is located in the same position as that of a base end portion of the first portion or is located closer to the wall portion than the base end portion of the first portion.

11. The connector according to claim 5, wherein
the first tip portion has a first portion that linearly extends along a protruding direction of the shaft portion,
the second tip portion has a second portion that linearly extends along the protruding direction of the shaft portion, and
in the protruding direction of the shaft portion, a terminal end portion of the second portion is located in the same position as that of a base end portion of the first portion or is located closer to the wall portion than the base end portion of the first portion.

12. The connector according to claim 1, wherein
the first tip portion is in line contact with the first contact portion, and
the second tip portion is in line contact with the second contact portion.

13. The connector according to claim 2, wherein
the first tip portion is in line contact with the first contact portion, and
the second tip portion is in line contact with the second contact portion.

14. The connector according to claim 3, wherein
the first tip portion is in line contact with the first contact portion, and
the second tip portion is in line contact with the second contact portion.

15. The connector according to claim 5, wherein
the first tip portion is in line contact with the first contact portion, and
the second tip portion is in line contact with the second contact portion.

16. The connector according to claim 8, wherein
the first tip portion is in line contact with the first contact portion, and
the second tip portion is in line contact with the second contact portion.

17. The connector according to claim 1, wherein
the first main body portion has a first cutout portion through which the first arm portion extends to outside from between the first main body portion and the second main body portion.

18. The connector according to claim 2, wherein
the first main body portion has a first cutout portion through which the first arm portion extends to outside from between the first main body portion and the second main body portion.

19. The connector according to claim 1, wherein
the second main body portion has a second cutout portion through which the second arm portion extends to outside from between the first main body portion and the second main body portion.

20. The connector according to claim 2, wherein
the second main body portion has a second cutout portion through which the second arm portion extends to outside from between the first main body portion and the second main body portion.
